(19) United States
(12) Patent Application Publication
(10) Pub. No.: US 2007/0028766 A1
(43) Pub. Date: Feb. 8, 2007

(54) Method for removing impurities from a gas

(76) Inventor: Ravi Jain, Bridgewater, NJ (US)

Correspondence Address: THE BOC GROUP, INC., 575 MOUNTAIN AVENUE, MURRAY HILL, NJ, 07974-2064, US

(21) Appl. No.: 11/500,132

(22) Filed: Aug. 7, 2006

Related U.S. Application Data
(60) Provisional application No. 60/706,327, filed on Aug. 8, 2005.

(51) Int. Cl. B01D 53/02

(52) U.S. Cl. 95/39

(57) ABSTRACT

The present invention provides for a method and apparatus for purifying carbon dioxide. Bacteria, pesticides and heavy metals impurities from carbon dioxide gas stream are removed using adsorption, water washing, electrostatic precipitation or filtration.

### FIELD OF THE INVENTION

The present invention provides a method of removing impurities from a gas. More particularly, this invention provides a method of removing impurities from a carbon dioxide gas.

### BACKGROUND OF THE INVENTION

Carbon dioxide is used in a number of industrial and domestic applications, many of which require the carbon dioxide to be free from various impurities. Unfortunately carbon dioxide obtained from natural sources such as gas wells, chemical processes, fermentation processes or produced in industry, particularly carbon dioxide produced by the combustion of hydrocarbon products, can contain metals, pesticides and bacteria impurities in addition to sulfur compounds such as carbonyl sulfide (COS) and hydrogen sulfide (H₂S), oxygenates such as acetaldehydes and alcohols, and aromatics such as benzene. When the carbon dioxide is intended for use in an application that requires the carbon dioxide to be of high purity, such as in the manufacture and cleaning of foodstuffs and beverage carbonation, medical products and electronic devices, the metals, the pesticides and other impurities contained in the gas stream must be removed to very low levels prior to use.

Depending on the application (metals removal required for electronics and food, removal of pesticides required for food/beverage) the removal of such as metals and pesticides may be required and methods to remove these impurities are desirable.

The present invention provides a simple and efficient method for achieving these objectives.

### SUMMARY OF THE INVENTION

One embodiment of the present invention is directed to a method for removing impurities from a gas stream comprising passing the gas stream through at least one treatment selected from the group consisting of adsorption, water washing, electrostatic precipitation and filtration.

Another embodiment of the present invention is directed to a method for removing impurities from a carbon dioxide gas stream comprising passing the carbon dioxide gas stream through at least one treatment selected from the group consisting of adsorption, water washing, electrostatic precipitation and filtration.

In an embodiment, the adsorption comprises passing the gas stream through absorption beds selected from uses an adsorbent selected from an activated alumina; and a zeolite or a zeolite in its ion exchange form.

In an embodiment, the zeolite is selected from the group consisting a 4A, 5A, 13X and NaY form, and the zeolite in its ion exchange forms. The water washing comprises treatments with an oxidant or a disinfectant in a packed column.

In an embodiment, the filtration uses a filter selected from the group consisting of microfilters, ultrafilters, nanofilters and non-porous filters.

In an embodiment, a compression treatment is performed prior to or after the at least one treatment selected from the group consisting of adsorption, water washing, electrostatic precipitation and filtration.

### BRIEF DESCRIPTION OF THE DRAWINGS

While the specification concludes with claims distinctly pointing the subject matter that Applicants regard as their invention, the invention would be better understood when taken in connection with the accompanying drawings in which:

FIG. 1 is a schematic description of the overall process for purifying carbon dioxide in a point of use carbon dioxide purification process; and

FIG. 2 is a schematic description of purifying carbon dioxide in a carbon dioxide production plant.

### DETAILED DESCRIPTION OF THE INVENTION

The carbon dioxide that is typically produced for industrial operations has a number of impurities present in it. These impurities will often be a concern for many uses of the carbon dioxide, but in the production of products intended for human consumption such as carbonated beverages, and electronic manufacturing the purity of the carbon dioxide is paramount and can influence the taste, quality, and legal compliance of the finished product.

The impure carbon dioxide which can be obtained from any available source of carbon dioxide will typically contain as impurities sulfur compounds such as carbonyl sulfide, hydrogen sulfide, dimethyl sulfide, sulfur dioxide and mercaptans, hydrocarbon impurities such as aldehydes, alcohols, aromatics, propane, ethylene, and other impurities such as water, carbon monoxide, metals and pesticides. This invention describes novel methods for the removal of some of the impurities such as metals, pesticides and bacteria. The impurity removal and analysis methods can be used in various ways depending on whether the carbon dioxide is purified at a production plant, or at the point of use. Various point of use applications of carbon dioxide include a beverage filling plant, a food freezing plant, an electronics manufacturing plant and a fountain type carbon dioxide dispensing location.

Removal of bacteria, metal and pesticide impurities will depend on whether the carbon dioxide is purified in a production plant or at the point of use. In a production plant these impurities will normally be removed either prior to the compression step or after the compression step. The methods for the removal of these impurities include adsorbent materials, water wash columns, electrostatic precipitators and filtration media. The adsorbent material can be non-specific adsorbents such as activated alumina or zeolites and specifically impregnated materials for the removal of various metal impurities. Electrostatic precipitators can remove metal impurities through use of an electric field. Water wash columns remove metals and other impurities such as pesticides by transferring them into an aqueous phase which is discarded. Ozone can be used in a water wash column to oxidize and/or degrade impurities such as bacteria and pesticides and to cause flocculation of metals impurities which are then removed in the discharge from the water wash column. Packed bed filtration or microporous filters can also be used for the removal of metals and other impurities. To minimize the pressure drop in this step filters with very low pore size are not feasible.

For point of use removal of bacteria, metals and other impurities a wider variety of options are available due to higher permissible pressure drop. In addition to adsorbent based methods a number of filters can be used. These include microfilters, ultrafilters, nanofilters and non-porous filters such as gas separation membranes. Some of these filters will remove all impurities above a certain size level and can remove virtually all the metal and pesticide impurities.

Various combinations of purification techniques described can be used to address various C0₂ purification needs. For point of use purification such as purification of carbon dioxide prior to beverage fill or electronic manufacturing the impure carbon dioxide will be transported from a storage tank into the purification equipment at flow typical of customer usage. These flow rates can range from 80 to 1,500 sm³/hr (standard cubic meters per hour) depending on the final application and the size of the production facility. The carbon dioxide will typically be at a pressure in the range of about 1.7 to about 21.5 bara with about 16 to about 20 bara being typical. In certain applications, particularly those related to the carbon dioxide for electronic cleaning, the pressures could range between 60 to several thousand bara.

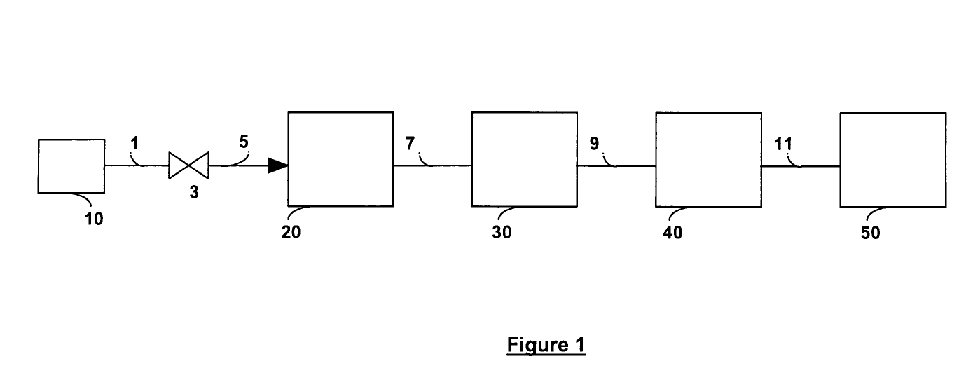

Turning to the figures, FIG. 1 is an overview of the carbon dioxide purification process at the point of use. Depending on impurities in the feed some components of this process can be eliminated. Carbon dioxide containing impurities is directed from tank 10 along line 1 through pressure regulator 3 and line 5 to a purification unit 20. An optional flow controller, not shown, can be employed to measure and control the impure carbon dioxide flow from tank 10. The carbon dioxide leaves the first purification unit through line 7 and enters a second purification unit 30. In a point of use purification the first purification unit 20 can be a sulfur removal unit and the second purification unit 30 can be a catalytic reactor and/or an adsorption unit. The gas exits the second purification unit 30 through line 9 and enters unit 40 for the removal of impurities such as metals, pesticides and bacteria and leaves unit 40 through line 40 and enters a carbon dioxide use process 50. The methods for the removal of these impurities include adsorbent materials, electrostatic precipitators and filtration media. The adsorbent material can be non-specific adsorbents such as activated alumina or zeolites and specifically impregnated materials for the removal of various metal impurities. Electrostatic precipitators can remove metal impurities through use of an electric field. Packed bed filtration or microporous filters can also be used for the removal of metals and other impurities. A number of filters can be used and include microfilters, ultrafilters, nanofilters and non-porous filters such as gas separation membranes. Some of these filters will remove all impurities above a certain size level and can remove virtually all the metal and pesticide impurities. Since carbon dioxide entering unit 40 is at high pressure, 16 to 20 bara, and unit 50 would typically be at less than 10 bara a high pressure can be tolerated across unit 40 and this gives the option of using filter which may cause large pressure drop such as the nanofilters.

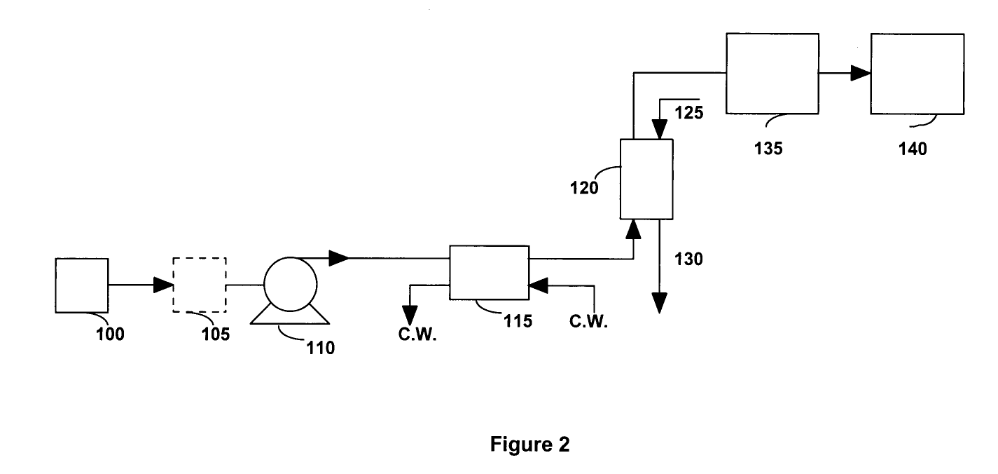

Purification of carbon dioxide in a carbon dioxide production plant using various aspects of this invention is shown in FIG. 2. Carbon dioxide from source 100 is sent to an optional metals/pesticides/bacteria removal unit 105. As discussed earlier this unit may consist of one or more purification processes chosen from adsorption, water wash column, electrostatic precipitator or a filtration unit. The methods for the removal of these impurities include adsorbent materials, water wash columns, electrostatic precipitators and filtration media. The adsorbent material can be non-specific adsorbents such as activated alumina or zeolites and specifically impregnated materials for the removal of various metal impurities. Electrostatic precipitators can remove metal impurities through use of an electric field. Water wash columns remove metals and other impurities such as pesticides by transferring them into an aqueous phase which is discarded. Ozone can be used in a water wash column to oxidize and/or degrade impurities such as bacteria and pesticides and to cause flocculation of metals impurities which are then removed in the discharge from the water wash column. Packed bed filtration or microporous filters can also be used for the removal of metals and other impurities. To minimize the pressure drop in this step filters with very low pore size are not feasible. The gas leaving unit 105 is compressed in unit 110, cooled in unit 115 and sent to an optional water wash unit 120. In practice either a water wash column as part of unit 105 or water wash column 120 is used. In water wash column 120, water stream 125 enters the column and a stream 130 containing impurities exits the column. The water wash column would typically contain packing materials such as rashig rings or structured packing and the flow of carbon dioxide stream is countercurrent to the flow of the carbon dioxide stream. As mentioned earlier incoming water stream 125 can contain ozone to facilitate removal of metal impurities and degradation of pesticide and bacteria impurities. Sufficient residence time is provided for the removal of these impurities.

The stream exiting the water wash column 120 enters a purification unit 135 which may contain modules for the removal of sulfur and hydrocarbon impurities, modules for liquefaction and distillation and analysis means. The gas leaving the purification unit 135 enters unit 140 which may be a carbon dioxide storage tank or a process utilizing carbon dioxide.

The industries or customers where the present invention will have utility include but are not limited to the manufacturing and cleaning of foodstuffs; the manufacture of electronics, electronic components and subassemblies; the cleaning of medical products; carbonation of soft drinks, beer and water; blanketing of storage tanks and vessels that contain flammable liquids or powders; blanketing of materials that would degrade in air, such as vegetable oil, spices, and fragrances.

### EXAMPLE 1

Testing was performed using a water wash column (10 cm in diameter) using 2.5 cm packing. The height of the column was about 1.0 meter. Carbon dioxide at a flow rate of 26.6 Sm³/hr and at a pressure of 0.5 barg was passed countercurrently to water stream at 0.4 liters per min. The carbon dioxide contained a heavy metal impurity at a concentration of about 140 ppb. About 80% of the metal impurity was removed by water wash.

Ozone at a concentration of 10 ppm was added to the water stream and over 95% removal of the heavy metal was obtained. Use of ozone improves the removal of metal impurities significantly in this case.

While the present invention has been described with reference to several embodiments and example, numerous changes, additions and omissions, as will occur to those skilled in the art, may be made without departing from the spirit and scope of the present invention.

What is claimed is:

1. A method for removing impurities from a gas stream comprising passing the gas stream through at least one treatment selected from the group consisting of adsorption, water washing, electrostatic precipitation and filtration.

2. The method as claimed in claim 1 wherein the gas stream is a carbon dioxide gas stream.

3. The method as claimed in claim 1 wherein said adsorption comprises passing the gas stream through absorption beds selected from uses an adsorbent selected from an activated alumina; and a zeolite or a zeolite in its ion exchange form.

4. The method as claimed in claim 1 wherein the zeolite is selected from the group consisting a 4A, 5A, 13X and NaY form.

5. The method as claimed in claim 1 wherein the water washing comprises treatments with an oxidant.

6. The method as claimed in claim 1 wherein the water washing comprises treatment with a disinfectant.

7. The method as claimed in claim 1 wherein said filtration uses a filter selected from the group consisting of microfilters, ultrafilters, nanofilters and non-porous filters.

8. The method as claimed in claim 1 wherein the gas stream further comprises a pre-treatment to remove sulfur compounds.

9. The method as claimed in claim 1 further comprising a compression treatment after at least one treatment selected from the group consisting of adsorption, water washing, electrostatic precipitation and filtration.

10. A method for removing impurities from a carbon dioxide gas stream comprising passing the carbon dioxide gas stream through at least one treatment selected from the group consisting of adsorption, water washing, electrostatic precipitation and filtration.

11. The method as claimed in claim 10 wherein said adsorption comprises passing the carbon dioxide gas stream through absorption beds selected from uses an adsorbent selected from an activated alumina; and a zeolite or a zeolite in its ion exchange form.

12. The method as claimed in claim 10 wherein the zeolite is selected from the group consisting a 4A, 5A, 13X and NaY form.

13. The method as claimed in claim 10 wherein the water washing comprises treatments with an oxidant.

14. The method as claimed in claim 10 wherein the water washing comprises treatment with a disinfectant.

15. The method as claimed in claim 10 wherein said filtration uses a filter selected from the group consisting of microfilters, ultrafilters, nanofilters and non- porous filters.

16. The method as claimed in claim 10 wherein the gas stream further comprises a pre-treatment to remove sulfur compounds.

17. The method as claimed in claim 10 further comprising a compression treatment after at least one treatment selected from the group consisting of adsorption, water washing, electrostatic precipitation and filtration.
